(19) United States
(12) Patent Application Publication
(10) Pub. No.: US 2023/0088417 A1
(43) Pub. Date: Mar. 23, 2023

(54) INFORMATION COMMUNICATION SYSTEM, STANDALONE DATA TRANSMISSION SYSTEM, DATA TRANSMISSION SYSTEM, APPARATUS, PROCESS, AND METHODS OF USE

(71) Applicant: Darrell W. Jackson, Bronx, NY (US)

(72) Inventor: Darrell W. Jackson, Bronx, NY (US)

(21) Appl. No.: 17/858,373

(22) Filed: Jul. 6, 2022

Related U.S. Application Data
(60) Provisional application No. 63/222,016, filed on Jul. 15, 2021.

(51) Int. Cl. G01S 19/48; G06F 9/30

(52) U.S. Cl. CPC G01S 19/485; G06F 9/3016

(57) ABSTRACT

An information communication system, a standalone data transmission system, a data relay system, apparatus for performing transmission, process of sending datum over distances, and various methods of use are presented. The present disclosure provides for instantaneous information transmission without the need for a data connection, broadband, internet, wifi, or the like.

### CROSS-REFERENCE TO RELATED APPLICATIONS

The present application claims priority to the U.S. Patent Application No. 63/222,016 which was filed on Jul. 15, 2021, which is hereby incorporated by reference herein in its entirety, including any figures, tables, or drawings.

### FIELD OF THE DISCLOSURE

This disclosure relates to an information communication system, a standalone data transmission system, a data relay system, apparatus for performing transmission, process of sending datum over distances, and various methods of use. More specifically, and without limitation, the present disclosure relates to a system for transmitting large amounts of data over a distance while occupying little to no bandwidth. More specifically, and without limitation, the present disclosure relates to an information transmission system, apparatus for sending, and various methods of transmitting.

### Copyright Notice

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. Darrell Jackson. All rights reserved.

### Background of the Disclosure

In recent times, and as the world has become increasingly connected, data transmission has become more and more problematic. Billions of dollars are being invested in infrastructure and the like so that large amounts of data can be transmitted through cellular, connected internet, wireless internet, satellite communications and much more.

Furthermore, time and money are being spent on space exploration. As humans grow more intent on space travel, such as visiting mars, communicating with spaceships and others in the outer atmosphere, or space outside of the earth's atmosphere, communication becomes a problem. Radio signals and/or radio waves can take a long time (relatively speaking) to reach a destination, such as communicating with a base located on Mars, or an astronaut near the moon, or a rover or other technological equipment. Some information from the National Aeronautics and Space Administration (NASA), states that a message won't reach Mars for about 20 minutes after sending. This makes controlling equipment, and potentially communicating with other humans, and the like, very difficult.

Furthermore, with a connected world, communication for reporters, telephone calls, video conferencing, and the like can be delayed through the sending and receiving of signals and/or messages. These delays can cause issues in communication, especially as distances grow. Furthermore, as distances grow, communication quality deteriorates.

In addition to delays in time in message sending, information transfer, and other communications, bandwidth and amount of data transmission is a very difficult problem facing the art. Furthermore, billions and billions of dollars are constantly being invested in bandwidth growth and data transmission.

Bandwidth or signal processing or the associations of the term “bandwidth” with data transmission has become known or associated with how much data can be transmitted over a particular source at a given time. In telecommunications, as one example, bandwidth is a frequency range of data transmission associated with a carrier signal. Bandwidth is a term used with data transmission for radio communications, and can be a term used to describe various meanings or purposes within communication.

To elaborate on bandwidth, as in some cases referred to herein, one of the main problems in modern data networks is reliable data transmission. More and more data from text messages, to phone calls, to video downloads, video streaming, uploads, pictures and other data is causing a huge impact on transmissions of data. The problem requires various complicated developments for efficient sending and receiving and/or routing algorithms. Many utilize mathematical modeling and complex computational modern networks for sending and/or receiving data due to limitations on bandwidth and the like.

Said another way, constant solutions are needed for transmissions, especially transmission conveying voice, data, image, signal or video information using continuous signals and/or occupying continuous bandwidth. Data transmission of this type of information is the transfer and/or reception of data over a point to point or point to multipoint communication channel. Some examples of this type of data transmission and/or communication include, but are not limited to transfer over copper wires, optical fibers, wireless communication channels, storage media, and computer buses. These transmission infrastructures have limitations both in physical and software technology.

Thus, there is a long-felt need in the art for efficiencies in the data transmission field. Particularly, there are long felt needs plaguing the art in data transmission around the efficiency and sending of large amounts of information in an efficient way.

Said another way, there is a long felt need in the art for an efficient transmission of data from a first device to a second device or through to multiple devices, and in some cases there is a need to send information, perhaps over great distances, without commonly used communication features such as internet or cellular networks.

Said another way, there is a need in the art for a means of communication and data transmission which more efficiently and effectively cooperates with and/or coordinates with data transmission over networks, such as cellular networks, internet networks, optical networks, copper wire network transmission and the like. Similarly, there is a need in the art for effectively transmitting and/or communicating over long distances, short distances, and the ability to view and/or understand a message without transmitting any information over a network at all. Furthermore, there exists a need in the art for the ability to transmit data without an internet connection, cellular connection or the like. Said another way, the present disclosure provides a means for transmitting or sharing information to multiple devices without any connection there between.

The disclosure herein provides these advantages and others as will become clear from the specification and claims provided.

### SUMMARY OF THE DISCLOSURE

An information communication system, a standalone data transmission system, a data relay system, apparatus for performing transmission, process of sending datum over distances, and various methods of use are presented. More specifically, and without limitation, the present disclosure relates to a system for transmitting large amounts of data over a distance while occupying little to no bandwidth. More specifically, and without limitation, the present disclosure relates to an information transmission system, apparatus for sending/receiving, and various methods of transmitting.

Thus, the present disclosure provides for a unique disclosure and means of transmitting data in a novel way.

Thus, it is a primary object of the disclosure to provide an information communication system, a standalone data transmission system, a data relay system, apparatus for performing transmission, process of sending datum over distances, and various methods of use that improves upon the state of the art.

Another object of the disclosure is to provide an information communication system, a standalone data transmission system, a data relay system, apparatus for performing transmission, process of sending datum over distances, and various methods of use that provides a process of sending information, such as a file, from a first device to a second device.

Yet another object of the disclosure is to provide an information communication system, a standalone data transmission system, a data relay system, apparatus for performing transmission, process of sending datum over distances, and various methods of use that uses a screen and the viewing of a screen as a means of data transmission.

Another object of the disclosure is to provide an information communication system, a standalone data transmission system, a data relay system, apparatus for performing transmission, process of sending datum over distances, and various methods of use that can transfer multiple files simultaneously.

Yet another object of the disclosure is to provide an information communication system, a standalone data transmission system, a data relay system, apparatus for performing transmission, process of sending datum over distances, and various methods of use that transfers information without using any bandwidth.

Another object of the disclosure is to provide an information communication system, a standalone data transmission system, a data relay system, apparatus for performing transmission, process of sending datum over distances, and various methods of use that provides a standalone system which does not use radio frequency, wireless communication, bluetooth, or the like.

Yet another object of the disclosure is to provide an information communication system, a standalone data transmission system, a data relay system, apparatus for performing transmission, process of sending datum over distances, and various methods of use that provides point to point viewing without data transfer.

Another object of the disclosure is to provide an information communication system, a standalone data transmission system, a data relay system, apparatus for performing transmission, process of sending datum over distances, and various methods of use that completes data transmission or relays information without the need for data transfer.

Yet another object of the disclosure is to provide an information communication system, a standalone data transmission system, a data relay system, apparatus for performing transmission, process of sending datum over distances, and various methods of use that uses sight.

Another object of the disclosure is to provide an information communication system, a standalone data transmission system, a data relay system, apparatus for performing transmission, process of sending datum over distances, and various methods of use that runs code without need for data transfer.

Yet another object of the disclosure is to provide an information communication system, a standalone data transmission system, a data relay system, apparatus for performing transmission, process of sending datum over distances, and various methods of use that does not require radio signal.

Another object of the disclosure is to provide an information communication system, a standalone data transmission system, a data relay system, apparatus for performing transmission, process of sending datum over distances, and various methods of use that can operate without bandwidth occupancy.

Yet another object of the disclosure is to provide an information communication system, a standalone data transmission system, a data relay system, apparatus for performing transmission, process of sending datum over distances, and various methods of use that can transmit data long distances at approximately the speed of light.

Another object of the disclosure is to provide an information communication system, a standalone data transmission system, a data relay system, apparatus for performing transmission, process of sending datum over distances, and various methods of use that utilizes internet or broadband to transmit large amounts of data while occupying minimal bandwidth.

Yet another object of the disclosure is to provide an information communication system, a standalone data transmission system, a data relay system, apparatus for performing transmission, process of sending datum over distances, and various methods of use that includes and utilizes external adapters.

Another object of the disclosure is to provide an information communication system, a standalone data transmission system, a data relay system, apparatus for performing transmission, process of sending datum over distances, and various methods of use that includes hardware which enables devices such as tablets, smartphones, and the like.

Yet another object of the disclosure is to provide an information communication system, a standalone data transmission system, a data relay system, apparatus for performing transmission, process of sending datum over distances, and various methods of use that includes a first program reader.

Another object of the disclosure is to provide an information communication system, a standalone data transmission system, a data relay system, apparatus for performing transmission, process of sending datum over distances, and various methods of use that utilizes a second program reader.

Yet another object of the disclosure is to provide an information communication system, a standalone data transmission system, a data relay system, apparatus for performing transmission, process of sending datum over distances, and various methods of use that can transmit efficiently and near immediately data to a large number of multiple recipients without clogging bandwidth and/or causing data loss.

Yet another object of the disclosure is to provide an information communication system, a standalone data transmission system, a data relay system, apparatus for performing transmission, process of sending datum over distances, and various methods of use that can run autonomously.

Another object of the disclosure is to provide an information communication system, a standalone data transmission system, a data relay system, apparatus for performing transmission, process of sending datum over distances, and various methods of use that tracks historical data.

Another object of the disclosure is to provide an information communication system, a standalone data transmission system, a data relay system, apparatus for performing transmission, process of sending datum over distances, and various methods of use that are easy to use.

Another object of the disclosure is to provide an information communication system, a standalone data transmission system, a data relay system, apparatus for performing transmission, process of sending datum over distances, and various methods of use that are accurate.

Yet another object of the disclosure is to provide an information communication system, a standalone data transmission system, a data relay system, apparatus for performing transmission, process of sending datum over distances, and various methods of use that can be used with various digital platforms.

Another object of the disclosure is to provide an information communication system, a standalone data transmission system, a data relay system, apparatus for performing transmission, process of sending datum over distances, and various methods of use that provides a user interface.

Yet another object of the disclosure is to provide an information communication system, a standalone data transmission system, a data relay system, apparatus for performing transmission, process of sending datum over distances, and various methods of use that is quick and efficient.

Another object of the disclosure is to provide an information communication system, a standalone data transmission system, a data relay system, apparatus for performing transmission, process of sending datum over distances, and various methods of use that are easy to program to various predetermined rule sets.

Yet another object of the disclosure is to provide an information communication system, a standalone data transmission system, a data relay system, apparatus for performing transmission, process of sending datum over distances, and various methods of use that are robust.

Another object of the disclosure is to provide an information communication system, a standalone data transmission system, a data relay system, apparatus for performing transmission, process of sending datum over distances, and various methods of use that utilizes image and image reading to transmit data and/or cause a particular information and/or data to appear on a subsequent device.

Yet another object of the disclosure is to provide an information communication system, a standalone data transmission system, a data relay system, apparatus for performing transmission, process of sending datum over distances, and various methods of use that are high quality.

Another object of the disclosure is to provide an information communication system, a standalone data transmission system, a data relay system, apparatus for performing transmission, process of sending datum over distances, and various methods of use that can transmit data via the display of an image or display of information on a first screen.

Yet another object of the disclosure is to provide an information communication system, a standalone data transmission system, a data relay system, apparatus for performing transmission, process of sending datum over distances, and various methods of use that provides for the transmission of large quantities of data without transmitting data but causing information to be seen by a camera on a second device as through the display of information on the screen of a first device.

Another object of the disclosure is to provide an information communication system, a standalone data transmission system, a data relay system, apparatus for performing transmission, process of sending datum over distances, and various methods of use that utilizes image and image reading to transmit data and/or cause a particular information and/or data to appear on a plurality of subsequent devices as many cameras may view information displayed on the screen of the first device.

Yet another object of the disclosure is to provide an information communication system, a standalone data transmission system, a data relay system, apparatus for performing transmission, process of sending datum over distances, and various methods of use that provides for simultaneous download.

Another object of the disclosure is to provide an information communication system, a standalone data transmission system, a data relay system, apparatus for performing transmission, process of sending datum over distances, and various methods of use that provides for improved remote access working.

Another object of the disclosure is to provide an information communication system, a standalone data transmission system, a data relay system, apparatus for performing transmission, process of sending datum over distances, and various methods of use that provides for improved mobility throughout offices and other workspace and/or remote access for enhanced working such as tablet to desktop connections.

These and other objects, features, or advantages of the present disclosure will become apparent from the specification and claims.

### BRIEF DESCRIPTION OF THE DRAWINGS:

FIG. 1 is an exemplary embodiment of the present disclosure; the embodiment showing a method by which the system carries out the process of data transmission.

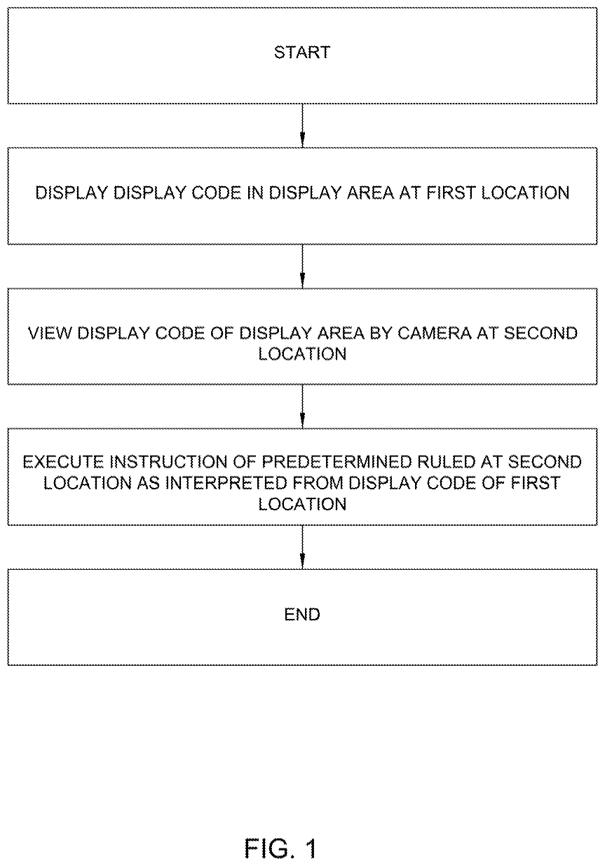

FIG. 2 is an exemplary embodiment of the present disclosure; the embodiment showing a method by which the system carries out the process of data transmission.

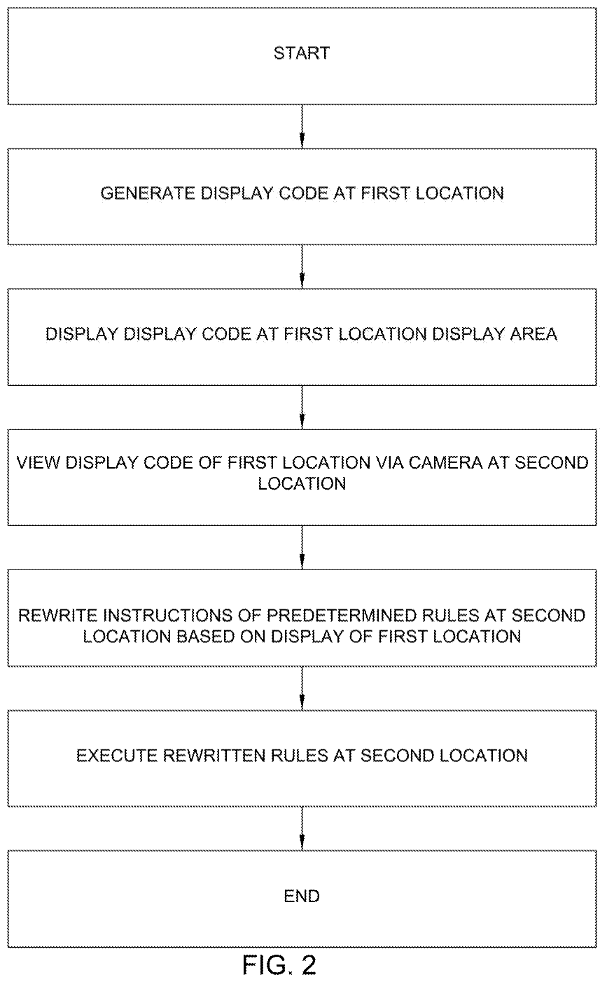

FIG. 3 is an exemplary embodiment of the present disclosure; the embodiment showing a method by which the system carries out the process of data transmission.

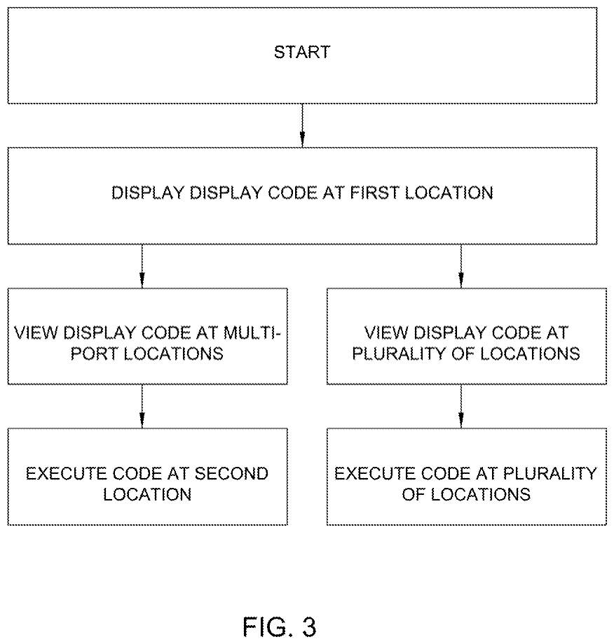

FIG. 4 is an exemplary embodiment of the present disclosure; the embodiment showing a method by which the system carries out the process of data transmission.

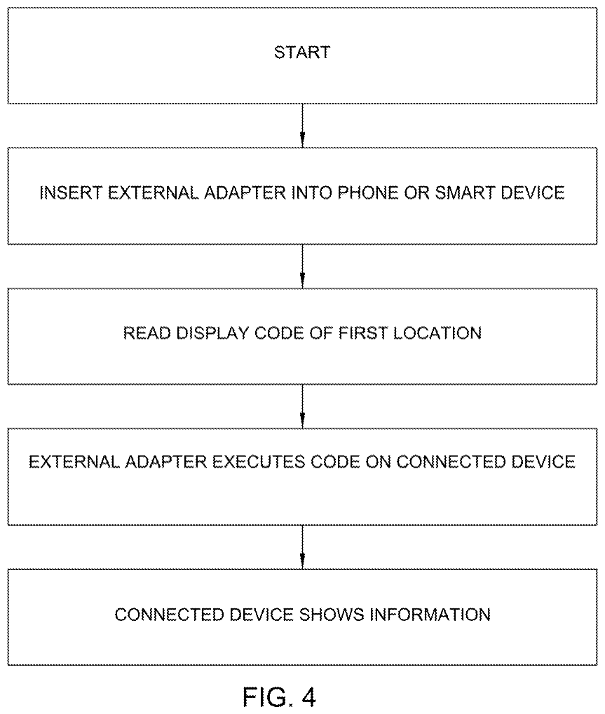

FIG. 5 is an exemplary embodiment of the present disclosure; the embodiment showing a method by which the system carries out the process of data transmission.

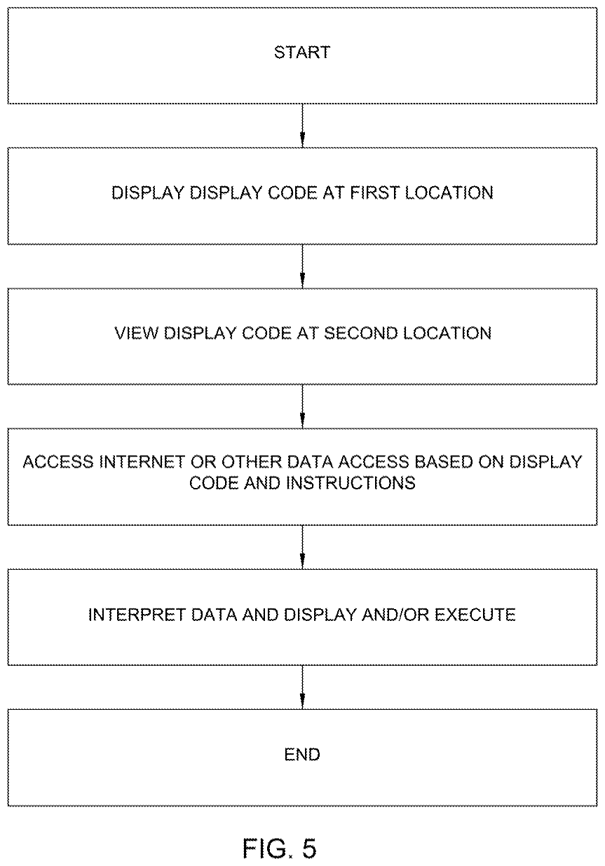

FIG. 6 is an exemplary embodiment of the present disclosure; showing parts of the present disclosure which may be associated with one another.

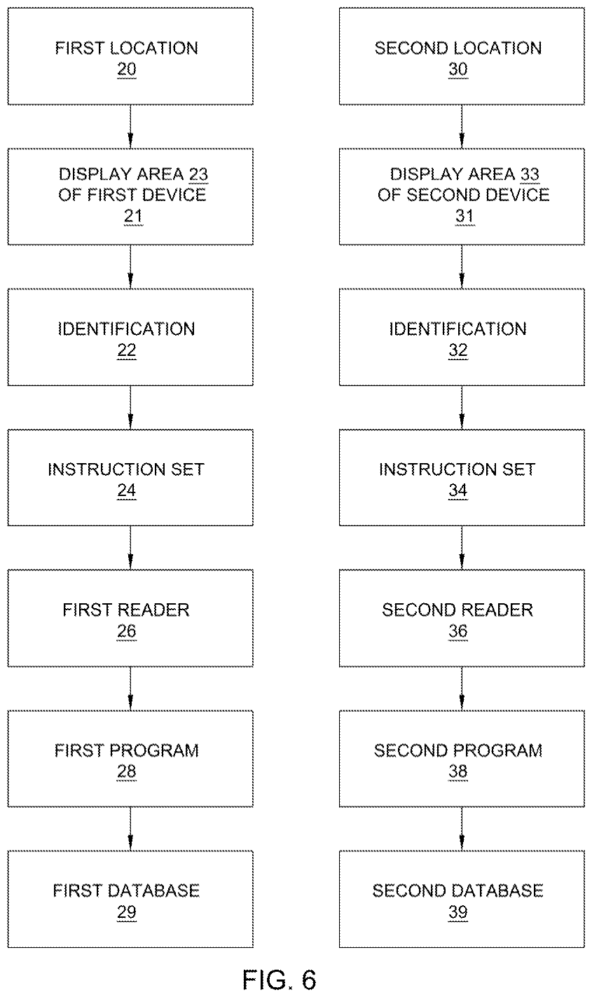

FIG. 7 is an exemplary embodiment of the present disclosure; showing parts of the present disclosure which may be associated with one another.

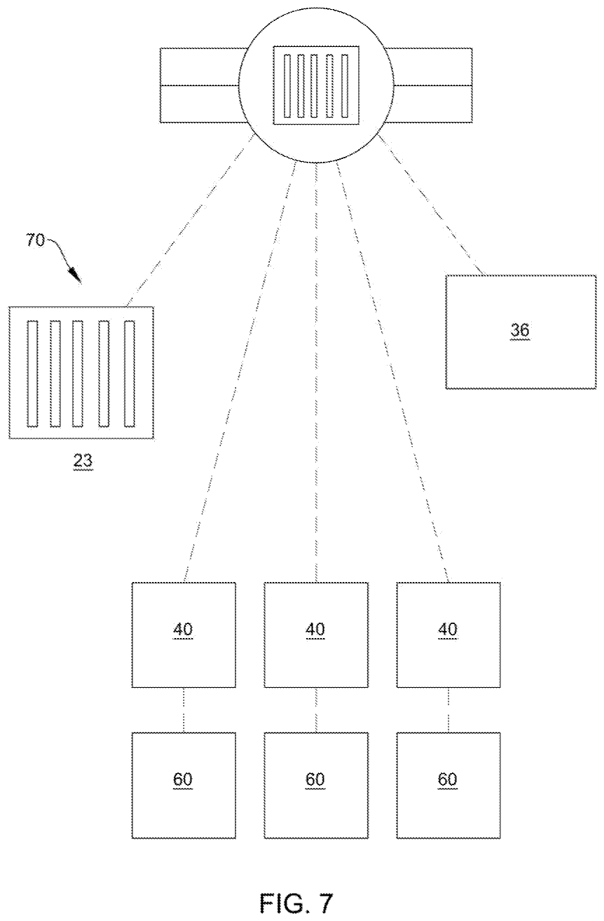

FIG. 8 is an exemplary embodiment of the present disclosure; showing parts of the present disclosure which may be associated with one another.

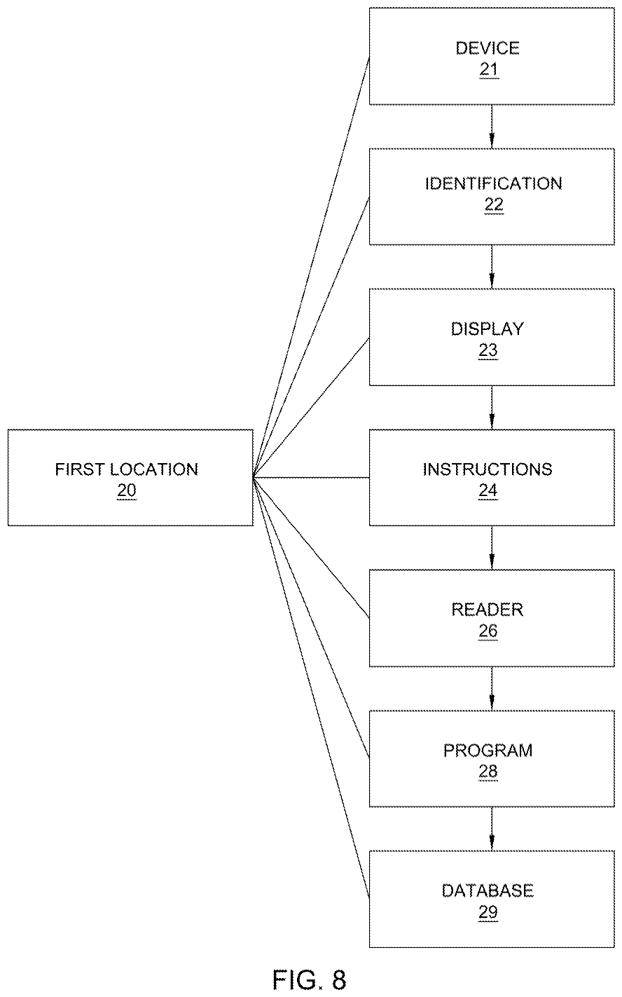

FIG. 9 is an exemplary embodiment of the present disclosure; showing parts of the present disclosure which may be associated with one another.

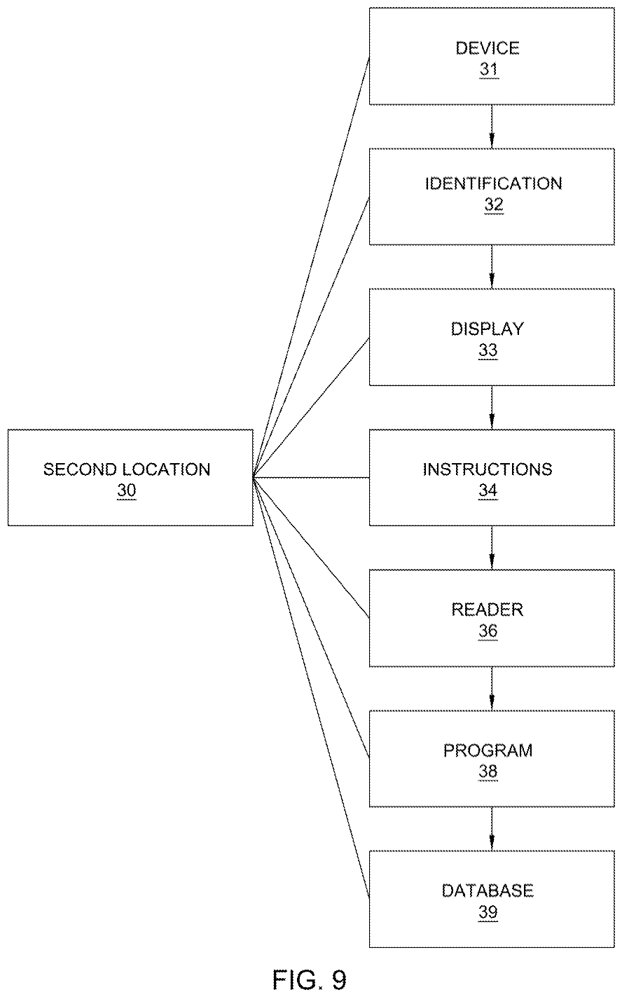

FIG. 10 is an exemplary embodiment of the present disclosure; showing parts of the present disclosure which may be associated with one another.

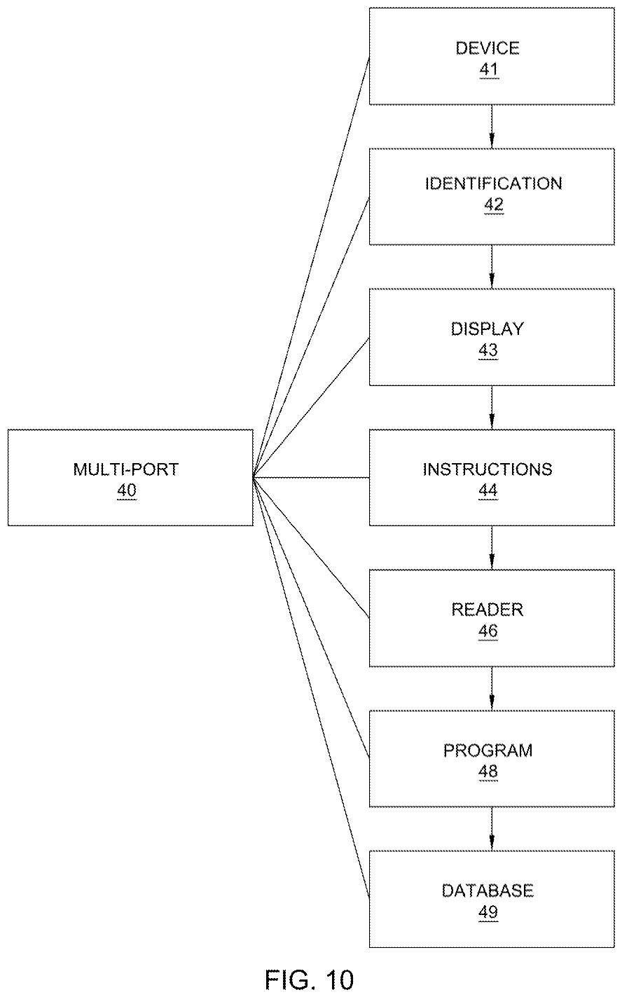

FIG. 11 is an exemplary embodiment of the present disclosure; showing parts of the present disclosure which may be associated with one another.

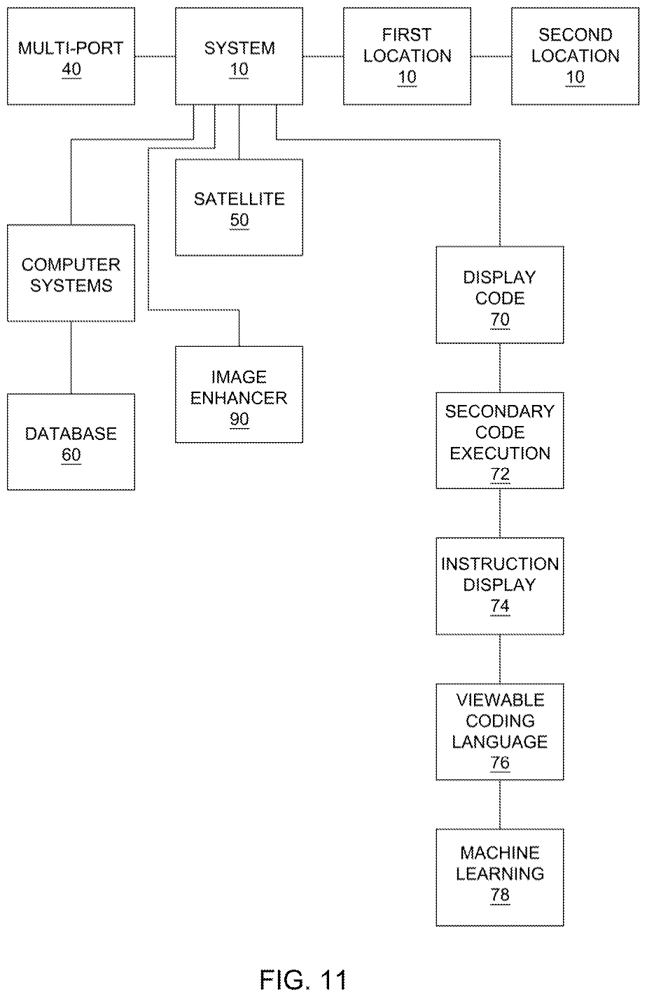

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In the arrangement shown, as one example, an information communication system, a standalone data transmission system, a data relay system, apparatus for performing transmission, process of sending datum over distances, and various methods of use are presented.

Some of this data capture includes, but is not limited to capturing images, object recognition within images, counting of objects within images, combined with location, spatial geometries, historical data including location of regular anomalies, and other information can be used to create customized information, identify patterns, and more.

System:

With reference to the figures, an information communication system, a standalone data transmission system, a data relay system, apparatus for performing transmission, process of sending datum over distances, and various methods of use 10 are presented (hereafter referred to as a “data system”, an “information relay system”, a “standalone data transmission system”, a “data relay system”, an “instantaneous transmission system”, a “communication system”, an “execution instructions system”, or simply “system”) is formed of any suitable size, shape and design.

In the arrangement shown, as one example, information relay system 10 may comprise remote servers, databases, application servers, application databases, program databases, mobile applications, and/or computers; all of which in continuity or as separate acts fulfill the functions disclosed herein. Instantaneous transmission system 10 may also include, in the embodiment(s) depicted, a graphical user interface, a user, a computing system, a communication and/or control system, an application server, and a mobile computing application, a plurality of remote servers, and at least one application database, among other components, features, and functions.

In the arrangement shown, as one example, the system 10 may also include a first location 20, a second location 30, a plurality of multi-port locations 40, may include a satellite 50, a plurality of databases 60, a code system 70, and a telescoping system 90, among other components, features, and functionality.

Graphical User Interface:

In the arrangement shown, as one example, system 10 may include a graphical user interface. Graphical user interface is formed of any suitable size shape and design and is configured to carry out the methods and embodiments disclosed herein. These methods, processes, and embodiments included, but are not limited to, allowing a user to view interact with, manipulate, and visually access environmental and system data and information, information related thereto, and/or view various data for various communications and/or transmissions and/or add information to a transmission system 10 and/or instantaneous communication system 10 and/or add information about a code or provide coding sequences and the like to carry out tasks and/or object data and/or change the settings and/or change the settings of the system 10 operation, and the like.

Graphical user interface is an exemplary method by which systems of the present disclosure may transmit information and/or make programming changes to the operation of system 10. Employing graphical user interface, enhances a user's interactions with system 10 in the form of awareness and knowledge of data within the system 10. System 10 provides direct links to a user's history, settings, programming, and other information related to a particular transmission and/or plurality of transmissions and/or a particular communication and/or a plurality of instructions and/or a particular display and/or display reader.

In this way graphical user interface provides for a means for a user to make adjustments to the operation and functionality of system 10. Additionally, graphical user interface provides direct interaction with the instantaneous transmission system 10, geometrical measurements of a display, objects, system speed, system trajectory, and more. Additionally, local geographic information with relation to the system can be added, viewed, or retrieved. For reference herein, “instantaneous” is used to describe information which may travel at the speed of light or approximately at the speed of light.

Display of Graphical User Interface: In the arrangement shown, as one example, system 10 includes a graphical user interface. Graphical user interface may include a display, which is configured to show and display information, including data, for review and interpretation by a user or plurality of users, or a plurality of users interacting with one another. Furthermore, display is configured to display a message to be read by a reader and/or display information used by a plurality of readers.

In the arrangement shown, as one example, an interactive user display is formed of a display screen, such as that of a desktop computer, laptop computer, monitor, tablet, smart phone, smart TV, projector, virtual reality display or any other device or form of a display. In the arrangement shown, as one example, interactive user display may comprise a series of coded information or the like, may comprise a series of interactive user display pages, however, the interactive user display may also be a display a user is interacting with, and consist of a single page or any other method of displaying information on a display as could be adapted to various size screens, devices, or user preferences.

User (or Plurality Thereof):

In the arrangement shown, as one example, system 10 includes a user. User may be any user interacting with or utilizing the system 10. This may include a first user displaying a message to be read by a second user. This may also include no users or machines that autonomously relay messages and/or transmissions to one another. This may include viewing, controlling, analyzing, manipulating, and/or interacting with system 10. User is not limited to a single user but may be a plurality of users.

Computing System:

In the arrangement shown, as one example, system 10 includes a computing system (or “computer”, or “computer platform”, or “computer system”). Computing platform is formed of any suitable size, shape, and design and is configured to provide computing support, power, and computing processing for both onboard computing functionality as well as communication for off-board or server computing functionality. In this way, any onboard computing system, among other components and features on top of the platform.

In the arrangement shown, as one example, system 10 includes a computer. Computer is formed of any suitable size, shape, and design and is configured to provide for the main off-board computing processing and implementation of computer handling of data from data gathering performed within the environment. The data processing may include, but is not limited to, artificial intelligence of sorting and organizing images gathered which may include stitching and object recognition and/or layer and layer recognition of continuous scans of a surface and/or structure and/or operations of system 10 and other components of system 10.

Onboard Computing System:

In one arrangement, as is shown, system 10 may include an onboard computing system (or “onboard computing device”). Onboarding computing system is formed of any suitable size, shape, and design and configured to handle onboard computing operations, as are necessary for the operation of system 10. Onboarding computing device may be connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Computing devices may be formed of and/or include any computing device capable of displaying and manipulating data in the manners described herein. Computing device may include for example a desktop computer, a laptop computer, a tablet, smart phone, or any other computing device or other interactive device.

Remote Computing System:

In one arrangement, as is shown, system 10 may include a remote computing system (or “remote computing device”). Remote computing devices are formed of any suitable size, shape, and design and configured to handle onboard computing operations, as are necessary for the operation of system 10. Remote computing devices may be located on a surface of the earth, below ground, and/or in space, on the moon, and the like.

Remote computing device may or may not be connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Computing devices may be formed of any computing device capable of displaying and manipulating data in the manners described herein. Computing devices may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices , including processor, memory, software and interactive user display, may be co-located with computing devices or located at different geographic locations. That is, computing devices may be made of any form of a device or system that individually or collectively performs the computing operations of system 10.

Application Server:

In the arrangement shown, as one example, system 10 comprises remote servers, databases, and/or computers that fulfill the functions disclosed and described herein. In the embodiment depicted, system 10 comprises an application server. Application server may comprise one or more computer systems adapted to transmit and receive data regarding selected datasets related to various users and/or datasets related to multiple users. Application server is adapted to query databases with unique identification codes to retrieve image information and associated surface information related to various surfaces system 10 has read over and/or gathered data from, via a camera or telescope reading device or the like, and/or has monitored and/or is monitoring.

Application server may transmit environmental data and/or surface related documents with respect to a single display and/or multiple displays co-located. Application server may also be adapted to query a database. This query includes receiving and sending surface identification data and or identification data related to the display screen being read. Additionally, application server may communicate with a cloud computing system or a mobile application, which can also be adapted to present the data in a form conducive to being viewed on a mobile device and/or handheld device.

As one of ordinary skills in the art may understand, application server, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server, and other database procedures may be carried out on computer-readable instructions and data stored on the customer's mobile computing device.

First Location:

In the arrangement shown, as one example, system 10 includes a first location 20. First location 20 is formed of any first location and may include a first device 21 having a first identification 22 and a first display 23. First location 20 may also include a plurality of instruction sets 24, a first reader 26 or first camera or first detection device. First location 20 may also include a first program 28 and a may also include a first database 29.

Second Location:

In the arrangement shown, as one example, system 10 includes a second location 30. Second location 30 is formed of any second location and may include a second device 31 having a second identification 32 and a second display 33. Second location 30 may also include a plurality of instruction sets 34, a second reader 36 or second camera or second detection device. Second location 30 may also include a second program 38 and a may also include a second database 39.

Multi-Port Locations:

In the arrangement shown, as one example, system 10 may also include a plurality of multi-port locations 40. Plurality of multi-port locations 40 are formed of any suitable location, plurality of locations and may provide for a plurality of readers all viewing the same and/or different screens and/or displays. Plurality of multi-port locations 40 may include a plurality of devices 41, each having an identification 42. Each of the plurality of devices 41 may have it's own display 43 and/or a plurality of displays 43. The plurality of multi-port locations 40 may also include a plurality of instruction sets 44, a plurality of readers 46 (or plurality of cameras” or “plurality of detection devices”). Plurality of multi-port locations 40 may also include a plurality of programs 48 and a may also include a plurality of databases 49.

Satellite:

In the arrangement shown, as one example, system 10 may also include a satellite 50 and/or relay image 50 (or simply “relay”). Relay 50 is formed of any suitable size, shape, and design and may be configured to relay a screen appearance to a reader, especially in the event that no direct line of sight exists between the first location 20 and the second location 30 and/or the plurality of multi-port locations 40.

In this way, satellite 50 may include both a reader and/or display. Satellite 50 may be limited to a mirror and/or plurality of mirror and/or amplifiers and/or lenses so as to enhance the appearance and/or size of the image being displayed.

Image being displayed is not limited to an image but may be a display area. This display area may be static, dynamic, or a combination thereof.

Plurality of Databases:

In the arrangement shown, as one example, system 10 may include a plurality of databases 60. Databases 60 are formed of any suitable size, shape, and design, and are configured to provide and/or store information. In the arrangement shown, as one example, and in some of the methods of use disclosed herein, each location has a database which the first program, second program and additional programs are designed to retrieve information from based on the images which are read at other locations.

Display Code:

In the arrangement shown, as one example, system 10 is designed to have a display code 70. Display code 70 is formed of any suitable size, shape, and design and is configured to display information, data, coding languages, instructions, communications, a combination thereof, and the like such that a reader at a second location can read the display and execute the code, retrieve the data, or the like. Display code 70 may include, but is not limited to a secondary code execution 72, instructions display 74, viewable coding language 76, machine learning coding 78, a combination thereof, and the like.

Image Enhancer:

In the arrangement shown, as one example, system 10 may also include an image enhancer 90. Image enhancer 90 may be formed of any suitable size, shape, and design and is configured to enhance an image that may be at a distance. Image enhancer 90 includes but is not limited to a telescope, other lenses, and the like which may amplify and/or clarify.

In addition to the above identified features, options, controls, and components, system 10 may also include other features and functionalities, among other options, controls, and components.

In Operation:

Standalone Method:

As one example of operation, the standalone method may be utilized to achieve some of the functionalities of the present disclosure. In the standalone method, and by one example, information may be desired to be sent from a first location 20 to a second location 30. First location and second location are used herein strictly as examples and many locations are hereby contemplated.

In this example, a first display located at a first location will display an image or plurality of images. For ease of example, this first location could be on earth, or perhaps on a space shuttle or space station, or perhaps on the surface of the moon. Subsequently at a second location, a reader is located. This reader can read the display from the first location. The reader can then execute the code corresponding to the information displayed on the screen.

Furthermore, information may not be limited to being displayed on a screen. Information and or the bar code and/or other displayed items may be displayed in a displayed area which might include a surface, a projection, a qr code on a table, or any other display surface, whether stagnate or able to change.

In one example, the image displayed on the first screen, may cause the second reader located at the second location to access a local server located at the second location. The server will have pre-stored information or instructions. The second reader can then execute those instructions which could display a message, cause an audio file to be played, cause a video to be played, cause code to be executed and the like.

In another example, the image displayed on the first screen, may cause the second reader located at the second location to access a local server located at the second location. The server will have pre-stored information, but additionally, the first display may be displaying information causing new code to be written or new information to be developed. In this way, a video chat could take place with live video feeds because the code can be re-written rapidly enough to display voice and video data in accordance with the code and display information (which may be thousands or millions or billions of bits of information).

In this way, a user can transmit video and audio appearances to subsequent locations which would mimic the first location without a radio frequency and without the need for bandwidth or the like. In this way, a user can send large messages from the surface of the earth to the surface of the moon nearly instantly but without radio waves which can be intercepted or lose quality.

Furthermore, in one example, when radio transmission is not utilized images can still be recognized by capturing devices, viewing the displayed area(s), and acting as the connection(s). Furthermore, symbol recognition can start the transferring of data. In another example, this method of data transfer also works in the digital environment, such as Virtual Reality (VR). Where, having a virtual capturing device(s), viewing the displayed area(s), act as a connection. Once symbols are recognized, data can be “transferred”.

Furthermore, and in another example, when using radio frequency and/or radio transmission, such as but not limited to, internet, bluetooth, wifi, etc., file data can be converted into symbol(s) and/or symbol images. These symbol images are then transmitted and/or can be transmitted using radio transmission. Symbols and/or images and/or display areas are not limited to static images but may be dynamic and/or a combination thereof. Furthermore, in other examples, this process can be carried out with or without radio transmission and/or a combination thereof. Furthermore, this method of data transmission can work internally and/or externally and/or a combination thereof.

Furthermore, while a first location and a second location are used by example, and for ease of explanation. Many locations can be used. For example, a single display can be read by readers from any number of locations, anywhere in the world for example, especially if a satellite and/or relays are involved. For example, thousands or more readers could be viewing the same display, and/or multiple displays at once. Similarly, a single display may have multiple displays within which could relay audio, video, coding files, and the like, for various purposes and for various locations.

In one way, this also allows for encrypted messages to be sent because there is no internet, radio frequency, or the like to be intercepted but only a coding language to be accessed at the second location after some type of display is made at a first location.

Connected Method:

In another example, the connected method is similar to the standalone method except that the connected method may also use internet or other data connections at each end of the transmission. The connected method, similarly, may be utilized to achieve some of the functionalities of the present disclosure. Still in the connected method, and by one example, information may be desired to be sent from a first location 20 to a second location 30. First location and second location are used herein strictly as examples and many locations are hereby contemplated.

In this example, a first display located at a first location will display an image or plurality of images. For ease of example, this first location could be on earth, or perhaps on a space shuttle or space station, or perhaps on the surface of the moon. Subsequently at a second location, a reader is located. This reader can read the display from the first location. The reader can then execute the code corresponding to the information displayed on the screen.

In the connected method example, the image displayed on the first screen, may cause the second reader located at the second location to access the internet or a database or an application server or the like located at the second location. In this way, the second location and/or first location may both access and retrieve information using bluetooth, wireless internet, wired internet communications such as fiber, cellular communication, and the like. Still, the server could have pre-stored information or instructions, including but not limited to, pre-stored information or instructions from an internet source or sources, or other connected information, to access in certain circumstances. The second reader can then execute those instructions which could display a message, cause an audio file to be played, cause a video to be played, cause code to be executed and the like.

In the connected method example, the image displayed on the first screen, may cause the second reader located at the second location to access a local server located at the second location or may cause the location to access connected sources, a combination thereof, or the like. In this way, the server will have pre-stored and potentially also write additional information gained from outside sources, but additionally, the first display may be displaying information causing new code to be written or new information to be developed. In this way, a video chat could take place with live video feeds because the code can be re-written rapidly enough to display voice and video data in accordance with the code and display information (which may be thousands or millions or billions of bits of information).

In this way, a user can transmit video and audio appearances to subsequent locations which would mimic the first location without a radio frequency and without the need for bandwidth or the like. In this way, a user can send large messages from the surface of the earth to the surface of the moon nearly instantly but without radio waves which can be intercepted or lose quality.

Furthermore, while a first location and a second location are used by example, and for ease of explanation. Many locations can be used. For example, a single display can be read by readers from any number of locations, anywhere in the world for example, especially if a satellite and/or relays are involved. For example, thousands or more readers could be viewing the same display, and/or multiple displays at once. Similarly, a single display may have multiple displays within which could relay audio, video, coding files, and the like, for various purposes and for various locations.

In one way, this also allows for encrypted messages to be sent because there is no internet, radio frequency, or the like to be intercepted but only a coding language to be accessed at the second location after some type of display is made at a first location.

Adapter Method:

In another example, the adapter method may include features which can connect to current devices such as mobile phones, tablets, televisions, and the like. In this way, an external adapter can be connected to a television screen so it can read information from a display and execute the standalone method or the connected method. External adapter is a small device suitable for working with a smartphone, tablet, computer, television, vehicle display, boat display, vehicle display, or other display to execute the methods of the present disclosure with devices that may not be outfitted to execute these methods and functions of the present disclosure.

Process of Sending Information:

In another example, system 10 is configured to send a file from a first device to a second device using the internet. Each device includes a camera, a visual display apparatus and a conversion program. In this process, as one example, a file can be sent from a first device to a second device and including the use of the conversion program. In this example, once an internet link is established between the first device and the second device, the hardware of the first device and the second device (the cameras and the visual display apparatus) will serve as a secondary connection to the internet connection.

In this way, the data being transferred from the first device to the second device will be visual and will occur via the secondary connection. With the secondary connection in place between the first device and the second device, a file can be transferred.

Said another way, in this transfer and process, the first device will act as a transmitter. Before the first device sends the file, the file is converted into a viewable graph and/or blueprint image using a conversion program of the first device. The first device will then display the viewable graph and/or blueprint image on the visual display apparatus of the first device.

Once the viewable graph and/or the blueprint image on the visual display apparatus of the first device is displayed, the camera of the second device will act as a receiver and view and/or capture the viewable graph and/or blueprint image on the visual display apparatus of the first device. Once the viewable graph and/or blueprint image on the visual display apparatus is viewed by the camera of the second device, the conversion program of the second device will convert the viewable graph and/or blueprint image back to the original form.

This same method and/or process can be implemented without the use of an internet connection between the first device and the second device. Without an internet and/or connection between the first device and the second device, a camera of one device would merely view the display apparatus of the other device.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. An instantaneous transmission system, comprising:
a first location;
a second location;
the first location having a display area;
the display area having a display code;
the second location having a reader;
wherein the reader of the second location reads the display area of the first location;
wherein the reader then executes a set of instructions depending on the display code of the display area.

2. The system of claim 1, further comprising:
wherein the set of instructions are stored on a local server at the second location;
wherein data can be reviewed and displayed at the second location, such data determined by the first location, from viewing the display area of the first location and executing the set of instructions at the second location.

3. The system of claim 1, further comprising:
a satellite.

4. The system of claim 1, further comprising:
a relay image.

5. The system of claim 1, further comprising:
a relay image;
wherein the relay image is formed of a plurality of mirrors;
wherein the relay image includes a plurality of amplifiers;
wherein the amplifiers enhance the appearance of the display area.

6. The system of claim 1, further comprising:
an image enhancer.

7. The system of claim 1, further comprising:
the first location having a first plurality of instruction sets.

8. The system of claim 1, further comprising:
the second location having a second plurality of instruction sets;
wherein the plurality of instruction sets may change if the display image of the first location provides instructions which change the instruction set.

9. The system of claim 1, further comprising:
the first location having a first device;
the first location having a first identification;
the first location having a first display;
the first location having a first reader.

10. The system of claim 1, further comprising:
wherein the first location is located in a digital environment.

11. The system of claim 1, further comprising:
wherein the first location is located in a digital environment;
wherein the reader of the second location is located in the digital environment.

12. The system of claim 1, further comprising:
the first location having a first device;
the first location having a first identification;
the first location having a first display;
the first location having a first reader;
the first location having a first detection device;
the first location having a first program;
the first location having a first database.

13. The system of claim 1, further comprising:
the second location having a second device;
the second location having a second identification;
the second location having a second display;
the second location having a second reader;
the second location having a second detection device;
the second location having a second program;
the second location having a second database.

14. The system of claim 1, further comprising:
a data connection;
wherein the data connection services a data connection between the first location and the second location.

15. The system of claim 1, further comprising:
a data connection;
a plurality of multi-port location;
wherein the data connection services a data connection between the plurality of multi-port locations.

16. The system of claim 1, further comprising:
an external adapter;
wherein the external adapter is configured to connect to devices.

17. The system of claim 1, further comprising:
a plurality of multi-port locations;
wherein each of the plurality of multi-port locations have at least one reader;
wherein the reader of each of the multi-port locations is viewing a same display area.

18. The system of claim 1, further comprising:
a plurality of multi-port locations;
each of the plurality of multi-port locations having a plurality of readers;
each of the plurality of multi-port locations having a plurality of devices;
each of the plurality of multi-port locations having an identification;
each of the plurality of multi-port locations having a display area;
each of the plurality of multi-port locations having a plurality of displays;
each of the plurality of multi-port locations having a plurality of executable programs;
each of the plurality of multi-port locations having a plurality of databases which store the plurality of executable programs.

19. A method of instantaneously transmitting information over long distances, comprising the steps:
providing a first display area at a first location;
displaying a display code at the first display area;
positioning a reader at a second location capable of viewing the first display area;
viewing the display code being displayed at the first display area;
executing code at the second location as instructed by the set of instructions at the second location based on the display code of the first location.

20. A method of instantaneously transmitting information over long distances; comprising the steps:
providing a first display area at a first location;
displaying a display code at the first display area;
positioning a reader at a second location capable of viewing the first display area;
viewing the display code being displayed at the first display area;
executing code at the second location as instructed by the set of instructions at the second location based on the display code of the first location;
providing data transmission access or internet connection at the second location;
accessing the internet at the second location to retrieve information based on the display code being displayed at the first location.
